(19) United States
(12) Patent Application Publication
(10) Pub. No.: US 2003/0003027 A1
(43) Pub. Date: Jan. 2, 2003

(54) Microdosing device for the defined delivery of small self-contained liquid volumes

(76) Inventors: Jens Albert, Zeitz (DE); Rainer Brautigam, Jena (DE); Thomas Henkel, Jena (DE); Gunter Mayer, Jena (DE); Andreas Schober, Darmstadt (DE)

Correspondence Address: JORDAN AND HAMBURG LLP, 122 EAST 42ND STREET, SUITE 4000, NEW YORK, NY, 10168, US

(21) Appl. No.: 10/204,375

(22) PCT Filed: Feb. 13, 2001
(86) PCT No.: PCT/EP01/01572

(30) Foreign Application Priority Data
Feb. 25, 2000 (DE) 100 10 208.5

(51) Int. Cl. B01L 3/02

(52) U.S. Cl. 422/100

(57) ABSTRACT

The invention relates to a microdosing device for the defined delivery of small self-contained liquid volumes. The aim of the invention is to provide a cost-effective microdosing device (m) which enables a defined delivery of small self-contained liquid volumes with liquid volumes that can be freely selected from part by volume to part by volume in a relatively large range without, as a result, influencing the dwell time of the dispenser that moves in relation to the settling area. To this end, the invention provides that a supporting body (1) comprises at least one first channel (2) which is connected to a pressurization means (d) that permits the channel (2) to be pressurized with a variably predeterminable pneumatic pressure pulse. Said channel (2) is connected to at least one pressure compensating bypass (3), whereby the minimum opening cross-section of the bypass (3) is no greater than twice the opening cross-section of the channel (2), and the channel (2) is provided, on the end (21) opposite the pressurization side, with at least one second channel (5) which accommodates the liquid to the dispensed and whose smallest opening cross-section is smaller than that of the bypass (3).

### BACKGROUND OF THE INVENTION

The invention relates to a microdosing device for the defined delivery of small self-contained liquid volumes which permits the generation of single drops having volumes in the range of from 10 nl up to 3 μl. Such pipetting systems find application in filling microcompartments such as, for example, nano-titer plates particularly for varying reagents as well as for manufacturing of biochips with spot sizes particularly in the range of 0.2 mm to 2 mm.

There are already several microdosing devices known for the same purpose of application as the present invention. So DE 197 06 513 A1, DE 198 02 367 C1, and DE 198 02 368 C1 describe microdosing devices in which a pressure chamber is provided limited by a membrane-like displacement body, in which the latter is provided with an actuator by aid of which the delivery of a defined liquid amount from the pressure chamber is effected via an outlet opening. With these solutions, the components mentioned are micro-mechanically manufactured. A piezo-stack actuator is utilized for the actuator device. Apart from a plurality of further components the above described solutions additionally need integrated valves to prevent a flow-back of the liquids from the exit channel.

Furthermore, a microdosing device is known from the publication “Microdosing”, a company paper of the enterprise microdrop Ltd., Norderstedt, 1995, in which a thin glass capillary is encompassed by a piezoelectric actuator which, when a voltage is applied, effects a contraction of the capillary range encompassed by it, and thus displaces a defined liquid volume from the capillary.

All the above mentioned solutions exhibit the disadvantage that their drive parameters such as frequency, amplitude, and pulse shape are strongly dependent on the viscosity of the mediums to be dispensed which can only be affected within certain limits by expensive control means. Furthermore, when a plurality of adjacent dispensing channels is provided, the integration density and the adjacent arrangement, respectively, of the same is limited due to the integration and the direct association, respectively, of the active members, which initiate a pressure pulse, upon the medium dispensing channels. Still further, the cleaning of the mentioned devices, in particular, when changing the medium, is complicated due to the structural design of said devices.

### SUMMARY OF THE INVENTION

It is an object of the present invention to provide a cost-effective microdosing device which enables a defined delivery of small self-contained liquid volumes with liquid volumes that can be freely selected from part by volume to part by volume within a relatively large range without, as a result, affecting the dwelling time of dispenser that moves relative to the settling area and which is free from the disadvantages of the prior art.

The object is realized by the features of the first claim. Advantageous embodiments are covered by the dependent claims.

The very essence of the invention consists in a structural decoupling of the pressure producing means from the proper dispensing means.

### DETAILED DESCRIPTION OF THE INVENTION

The invention will be explained hereinafter in more detail by virtue of schematical embodiments. There is shown in:

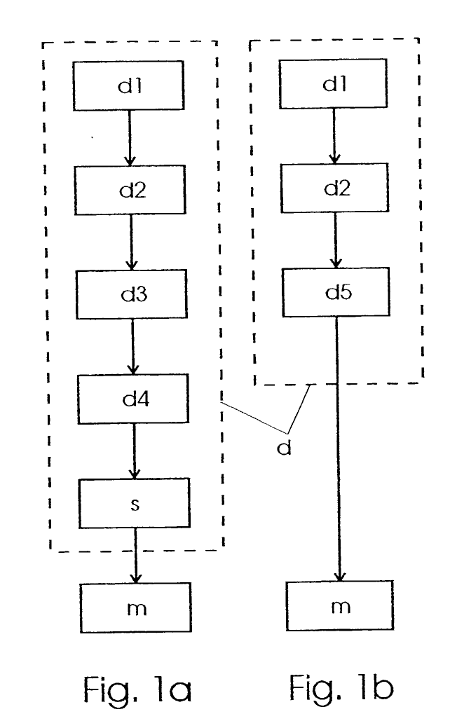

FIG. 1a and 1b feasibilities for pneumatically applying pressure to the proposed microdosing device,

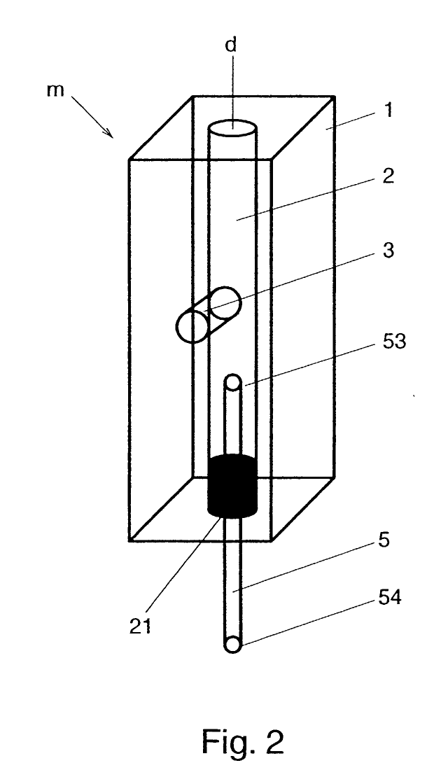

FIG. 2 a first embodiment of the invention in a transparent Perspective view,

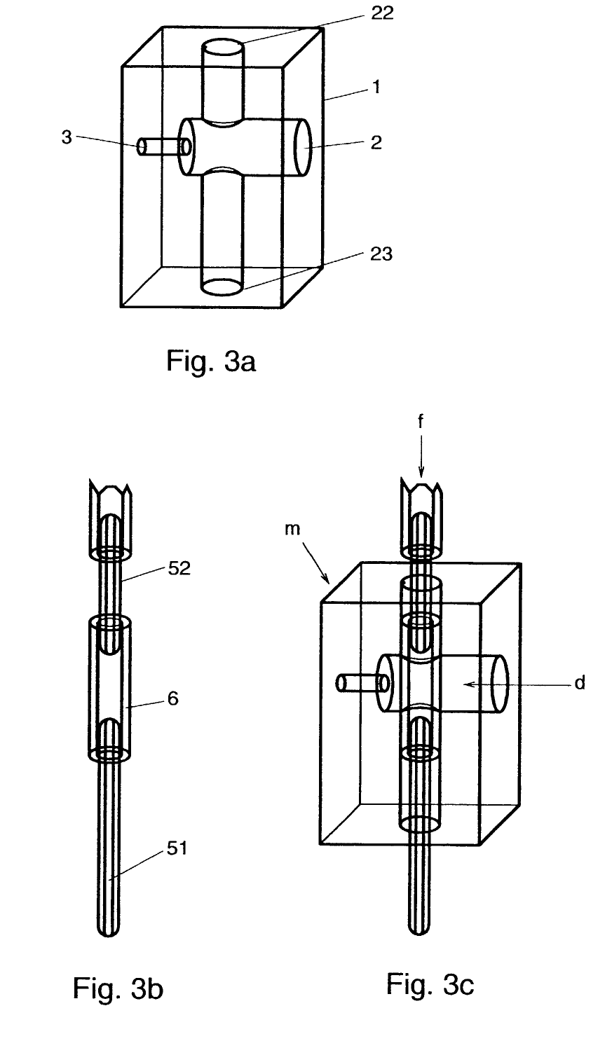

FIG. 3a a supporting body of a second embodiment of the invention in a transparent perspective view,

FIG. 3b a specially designed capillary to be implemented in a supporting body according to FIG. 3a,

FIG. 3c the units of FIG. 3a and FIG. 3b in an assembled state,

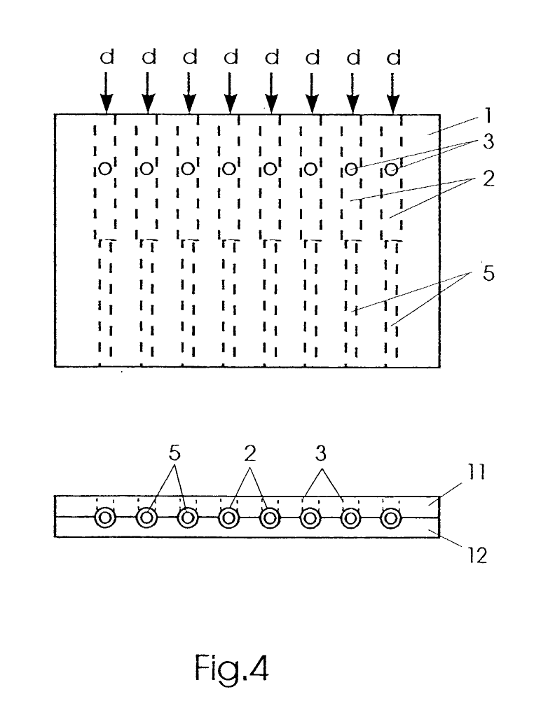

FIG. 4 a possibility of integrating a plurality of microdosing devices in a common support, and

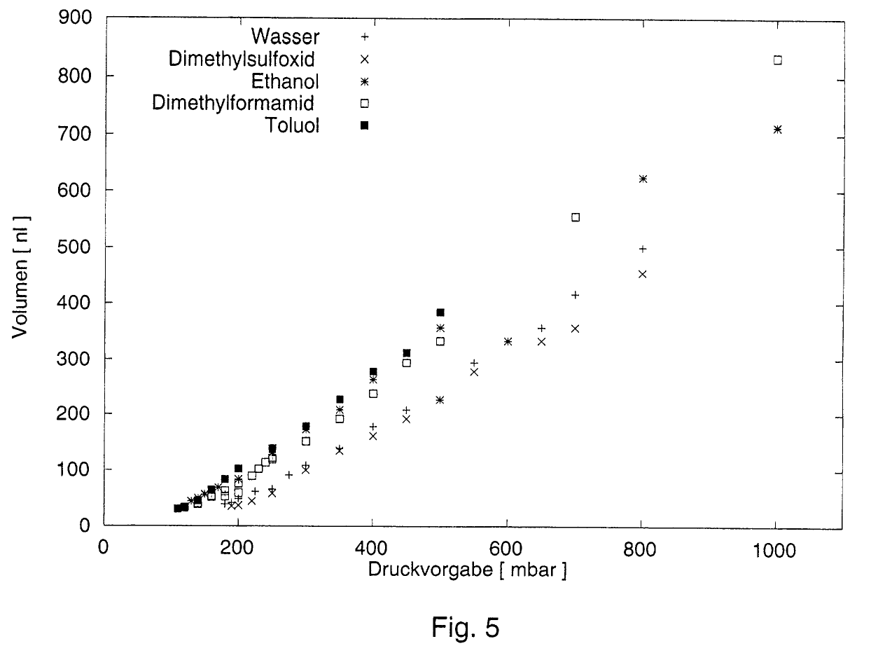

FIG. 5 by exemplification, the plotting of the volume of a liquid dispensed from a filled capillary as a function of the pressure preset for producing a pressure pulse for different liquids.

FIGS. 1a and 1b show feasibilities for pneumatically applying pressure to the proposed microdosing device m. Thereby, in FIG. 1a, d1 represents a pneumatic pressure supply device, d2 a pressure regulator, d3 a throttle valve, d4 a pressure reservoir, and s a manipulation valve. Same units in FIG. 1b are provided with identical reference numbers, whereby d5 represents an acoustic, mechanic, magnetic or electromagnetic device to be constructed according to the prior art and which is for generating a pneumatic pressure pulse.

FIG. 2 shows a first possible embodiment of a microdosing device m in a transparent and perspective view, comprising a supporting body 1 into which a first channel 2 is provided, said first channel 2 being connected to a pressurizing means d at its upper end, whereby the pressurizing means d of the example will include the units which are enclosed in FIG. 1a by dashed-line frame. When operating the manipulation valve s (refer to FIG. 1a) and when there is a variably preselectable pressure in the pressure reservoir d4, a pneumatic pressure pulse can be applied to the channel 2. Thereby the entire second channel 5 filled with the liquid to be dispensed (not shown) will be emptied either all at once or only a partial amount thereof in the form of a drop from out of the nozzle-like designed end 54 (not shown), depending on the preselectable force and duration of the pressure pulse. In the example, the second channel 5 is mounted within the channel 2 by way of a mounting and sealing means 4. According to FIG. 2, in which the channel 5 is designed as a capillary, the liquid to be dispensed will be taken up by a simple immersion into a not shown container which contains the respective liquid. In the present example the inner diameter of the capillary of channel 5 is 0.6 mm and in the nozzle-like designed end 54 between 50 . . . 100 μm The very essence is, however, that the first channel 2 is provided with a bypass 3 which effects a pressure balance to ambience, said bypass, in the present example, being designed as a borehole across the supporting body 1. Thereby, the cross-section of the opening of the channel 2 which, in the present example, has an inner diameter of 4 mm at a channel length of 4 cm, is designed wider than the cross-section of the opening of the bypass 3 which, in the present example is given an inner diameter of 1.2 mm. The end portion 53 of the second channel 5 which ends into the first channel 2 is arranged below the attachment place for the bypass 3 and the smallest opening cross-section of the channel 5 within the nozzle-like designed end 54 is defined smaller than the opening cross-section of the bypass 3. Thus it is ensured that, after actuating a pressure pulse of preselectable power and duration, a desired amount of liquid to be dispensed is pushed out from the capillary 5 and already, with the control valve s (FIG. 1a) still being open, an immediate breakdown of pressure takes place in the channel 2 via the bypass 3. Thus, when a further pressure pulse is applied to the channel 2 identical starting conditions are given for the next drop to be dispensed. The size of the pressure reservoir d4 to be used is preselectable at will, depending on the operation mode of the entire device; in designs which have been realized, it has been set between 2 μl to 20 ml, in particular to 200 μl.

FIG. 5 shows, as a modification of FIG. 1a, the volume of a liquid dispensed from a capillary 5, which was filled with maximally 5 μl, in dependence on the pressure preselected by the pressure regulator d2 which generates the pressure pulse, the liquid being exemplified by water and the organic solvents ethanol, dimethylformamide, dimethylsulphoxide, and toluol.

Provided that the capillary contains, for example, 5 μl dimethylformamide, and provided that the microdosing device m is operated with pressure pulses, whereby the pressure pulses are generated by applying a pressure of 220 mbar to the pressure reservoir d4, and a subsequent opening of the regulator valve, then, up to the complete depletion of the capillary 5, 62 single drops of a drop volume of 80 nl are dispensed at frequency of 2.3 Hz.

FIG. 3a schematically shows a supporting body according to a second possible embodiment of the invention in a transparent and perspective view. In said supporting body the first channel 2, which is connected to a pressurizing means d (refer to FIG. 3b), is provided on both of its sides with channel sections 22, 23 which are connected to the channel 2 via breakthroughs and are in mutually opposing alignment. Into these channel sections 22, 23 an interrupted capillary path 51, 52 is insertable, whereby the capillary paths 51, 52 are connected in the interrupted range by a deformable sealing membrane 6. In the example as shown in FIG. 3b, the interrupted capillary paths are formed by two tubular capillaries which are connected to each other and mutually spaced by a hose-like membrane 6. The membrane range 6 mentioned, when in the installed state (refer to FIG. 3c), is positioned in such a manner that it comes to lie within the first channel 2 and that it will be sealingly captured by the channel sections 22, 23 outside of the deformable membrane range 6, whereby only a pneumatic pressure pulse at the channel 2 can be applied to the deformable membrane range 6. In analogy to the embodiment according to FIG. 2, the channel 2 again is provided with a bypass 3. In the present example, the greatest inner diameter of the channel 2 is 4 mm, the diameter of the channel sections 22, 23 which, in the example, have been provided as bores in the supporting body 1 is 2 mm, the inner diameter of the capillary paths 51, 52 is selected in analogy to FIG. 2, whereby the capillary path 51 on the outflow side again shall be designed nozzle-like (not shown). The inner diameter of the bypass 3 is, in an embodiment according to FIG. 3a, 1.8 mm. In a modification of FIG. 2, the inlet portion of the capillary path 52 is connected to a liquid reservoir or to a liquid inlet f so that a continuous liquid supply for the liquid to de dispensed is given. When operating the device, it should be observed that apart from the capillary path 52 at least the membrane range 6 ought to be always completely filled with liquid to ensure reproducible drop sizes. The capillary path 51 on the outflow side can be designed shorter than selected in FIG. 2 and is, in the present example, 25 mm since, due to the continuous liquid supply, this section must not take in the entire liquid to be dispensed. With an embodiment according to FIG. 3c, drops of volumes in a range from 30 nl to 2 μl can be generated at a nozzle cross-section between 50 . . . 200 μm in the capillary outlet range 51 and at pneumatic pressure pulses.

A miniaturization of a device according to FIG. 3 and arrangements of a plurality of such devices one beside the other lies within the scope of the invention and can be more easily achieved, due to the permanent fluid supply, than according to FIG. 2.

It lies also within the scope of the invention that a respective channel 2 is connected to a plurality of pressure balancing bypasses 3, whereby the sum of the minimal cross-sections of the openings of the bypasses 3 is maximally twice the cross-section of the opening of the channel 2.

In FIG. 4 there is schematically indicated the possibility of integrating a plurality of microdosing devices in a common supporting body 1. Thereby, in the present example, the necessary channels 2 and 5 are congruently provided by means of microsystem technologies in two plate-like supporting bodies 11, 12 each, (refer to the lower part of FIG. 4). To this end, in one of the supporting bodies, here 11, recesses are inserted for formation of the bypasses which have to be provided per channel 2. The two plate-like supporting bodies 11, 12 can be connected with one another, for example, by anodic bonding. In the present example, the basic design of the individual units 2, 3, and 5 substantially is in analogy to the embodiment according to FIG. 2, whereby the cross-section of the channels 2 is 1 mm² at a channel length of 3 mm, the cross-section of the channels 5 is 0.24 mm² at a channel length of 30 mm, which again exhibit a nozzle-like design of a cross-section of 10 μm² in the drop dispensing range, and the cross-section of the bypass is 0.6 mm². In the present example each of the channels 2 shall be provided with a separate pressurizing means. A combination of said pressurizing means d into only one pressurizing means which comprises all channels 2 is thinkable, however, requires a variation at least of the cross-sections of the channels 2, since the pressure pulse propagates in a Gaussian distribution, so that there will not be applied an identical pneumatic pressure pulse to each of the channels at an identical design of the channels 2.

An analogous miniaturized design of a microdosing device according to FIG. 3c is also thinkable, the setup being, however, more complicated than that shown in FIG. 4. Furthermore, with such an embodiment it can be provided that the interrupted capillary path is arranged in one plane only rather than being encompassed by a membrane from all sides, as shown in FIG. 3b.

In contrast to the comparable solutions of the prior art, the present invention permits, for example, when applied in accordance with FIG. 1a and after calibration, a setting of the desired drop volume over a wide range of volume exclusively via the pre-set pressure which will be applied to the pressure reservoir.

The calibration function which is linear over wide ranges and which is detected on the basis of the dependency of the drop volume on the preset pressure (refer to FIG. 5) is carried out, according to the invention, device specifically by experiment once for each respective reagent, then being at one's disposal until the configuration of the device is changed. The precision can be additionally increased when using non-linear calibration functions.

A computation of the calibration function on the basis of the solvent parameters density, viscosity, surface tension, on diverse device parameters as well as on empirical device indices is possible.

By integration of the calibration function and in feeding the set of parameters of the reagent into a control software, the user only needs to preset the drop volume to be dispensed.

Thus, the operation expenditures on the user side are reduced to the presetting of the drop volumes, the target coordinates x, y, z (when coupled between the microdosing device and a positioning system) as well to the reagent parameters which can be provided from an internal database.

Moreover, a control of the respective filling state of the microdosing device is possible on the software side, whereby a fully automatic recharging of the reagents can be realized.

Hence, one and the same microdosing device is capable of dispensing drops of different volumes over a wide range even during the charging cycle of a drop receiving carrier.

A complete blowing out of the capillaries in one step is achieved by temporarily closing the bypass 3 in devices which are designed according to FIG. 2 and by actuating a pressure pulse. This line of proceeding, which can be easily automated, permits in combination with the alternating complete filling of the capillaries with flushing liquids and cleaning fluids as well as reagents for setting the process conditioned necessary wetting behavior of the inner capillaries an adaptation to the fast change of the operation reagents preferably during the cycle of charging a drop carrier. In contrast to the comparable solutions of the prior art, embodiments according to FIGS. 2 and 3 permit the execution of pipetting operations without a direct contact between the medium to be dispensed and the mechanical, electromechanical active or passive components or auxiliary media. Thus, the proposed microdosing device extends the range of media and reagents accessible to the method of microdosing in particular to highly reactive or highly corrosive media such as, for example, acid chloride, trifluoroacetic acid, to metal-organic compounds, such as, for example, Grignard-reagents, solutions of metal-amide (LDA), reducing agents such as, for example, lithium-aluminum hydride and the like.

In addition to the advantageous possibilities, described at the beginning, by application of the claimed device, the use of the same permits the realization of defined flexible dilution procedures as an essential part of most protocols for performing assays such as receptor-binding studies, radio-immunoassays, enzyme immunoassays etc. in which the target value to be determined results from the concentration dependence of a measuring value.

### LIST OF REFERENCE NUMERALS

1, 11, 12—supporting body

2—first channel

21—end of channel 2 opposite the pressurized side of the same

22, 23—channel sections

3—bypass

4—mounting and sealing means

5—second channel (capillary)

51, 52—interrupted capillary path

53—end portion of channel 5 ending into channel 2

54—liquid dispensing end of channel 5

6—deformable membrane

d—pressurizing means

d1—pressure supply device

d2—pressure regulator

d3—throttle valve

d4—pressure reservoir

d5—an acoustic, mechanic, magnetic or electromagnetic device generating a pneumatic pressure pulse

f—a liquid reservoir or a liquid inlet

m—microdosing device

s—manipulation valve

1. Microdosing device for the defined delivery of small self-contained liquid volumes comprising a supporting body (1) including at least one first channel (2) being connected to a pressurizing means (d) being adapted for applying said channel (2) with a variably presettable pneumatic pressure pulse, whereby said channel (2) is connected to at least one pressure balancing bypass (3), whereby the minimal opening cross-section of the bypass (3) is maximally twice the opening cross-section of the channel (2), and the channel (2) is provided, on the end (21) opposite to the pressurizing side with at least one second channel (5) which receives the liquid to be dispensed and whose smallest opening cross-section is smaller than that of the bypass (3).

2. Microdosing device as claimed in claim 1, characterized in that said second channel (5) is formed by an interrupted capillary path (51, 52) which is provided in the interrupted section with a deformable membrane (6) sealing the capillary path towards outside, which is arranged in said first channel (2) and to which a pneumatic pressure pulse can be applied.

3. Microdosing device as claimed in claim 2, characterized in that the inlet portion (52) of the capillary path (51, 52) is connected to a liquid reservoir and to a liquid inlet (f), respectively.

4. Microdosing device as claimed in claim 2, characterized in that the first channel (2) is provided on both of its sides with channel sections (22, 23) which are connected to the channel (2), said channel sections (22, 23) including the interrupted capillary path (51, 52) and sealingly capture the capillary paths (51, 52) outside of the deformable membrane range (6).

5. Microdosing device as claimed in claim 1, characterized in that end portion (53) of the second channel (5) ending into the first channel (2) is arranged below the attachment place for the bypass (3).

6. Microdosing device as claimed in one of the preceding claims, characterized in that the second channel (5) is nozzle-like designed at its liquid dispensing end (54).

7. Microdosing device as claimed in one of the preceding claims, characterized in that a plurality of first channels (2), and bypasses (3) associated to said plurality of first channels (2), and second channels (5) are inserted into a plate-like supporting body (1) by means of microsystem technologies.

8. Microdosing device as claimed in claim 7, characterized in that the plate-like supporting body is constituted by at least bipartite plate-like supporting bodies (11, 12) which are planarly connected to each other, whereby the units (2, 3, 5) to be provided are inserted by means of microsystem technologies at least in one of said supporting bodies (1 or 12).

9. Microdosing device as claimed in claim 1, characterized in that one respective channel (2) is provided with a plurality of pressure-balancing bypasses (3), whereby the sum of the minimal opening cross-sections of the bypasses (3) is maximally twice the opening cross-sections of the channel (2).
